(19) United States
(12) Patent Application Publication
(10) Pub. No.: US 2026/0362117 A1
(43) Pub. Date: Nov. 12, 2026

(54) COMMUNICATION OF CHANNEL INFORMATION CAPABILITIES IN OPEN RADIO ACCESS NETWORKS

(71) Applicant: QUALCOMM Incorporated, San Diego, CA (US)

(72) Inventors: Akashnil ROY, Kolkata (IN); Aman Kumar SINGH, Hyderabad (IN)

(21) Appl. No.: 19/202,693

(22) Filed: May 8, 2025

(51) Int. Cl. H04W 8/22; H04B 7/06; H04W 16/28; H04W 24/10

(52) U.S. Cl. CPC H04W 8/22; H04B 7/0626; H04W 16/28; H04W 24/10

(57) ABSTRACT

This disclosure provides methods, components, devices and systems for communication of channel information capabilities in open radio access networks. For example, a radio unit (RU) may transmit a capability report including one or more parameters associated with channel information capabilities of the RU, where the channel information capabilities are associated with a beamforming type. A distributed unit (DU) may receive the capability report and transmit a channel information reporting configuration to the RU in accordance with the one or more parameters. The RU may transmit, for reception at the DU, a channel information report in accordance with the channel information reporting configuration and the beamforming type.

### TECHNICAL FIELD

This disclosure relates generally to wireless communication, and more specifically to systems, devices, methods, and techniques associated with communication of channel information capabilities in open radio access networks.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communication by a radio unit (RU) is described. The method may include transmitting a capability report including one or more parameters associated with channel information capabilities, where the channel information capabilities are associated with a beamforming type, receiving a channel information reporting configuration in accordance with the one or more parameters, and transmitting a channel information report in accordance with the channel information reporting configuration and the beamforming type.

An RU for wireless communication is described. The RU may include a processing system that includes processor circuitry and memory circuitry that stores code. The processing system may be configured to cause the RU to transmit a capability report including one or more parameters associated with channel information capabilities, where the channel information capabilities are associated with a beamforming type, receive a channel information reporting configuration in accordance with the one or more parameters, and transmit a channel information report in accordance with the channel information reporting configuration and the beamforming type.

Another RU for wireless communication is described. The RU may include means for transmitting a capability report including one or more parameters associated with channel information capabilities, where the channel information capabilities are associated with a beamforming type, means for receiving a channel information reporting configuration in accordance with the one or more parameters, and means for transmitting a channel information report in accordance with the channel information reporting configuration and the beamforming type.

A non-transitory computer-readable medium storing code for wireless communication is described. The code may include instructions executable by one or more processors to transmit a capability report including one or more parameters associated with channel information capabilities, where the channel information capabilities are associated with a beamforming type, receive a channel information reporting configuration in accordance with the one or more parameters, and transmit a channel information report in accordance with the channel information reporting configuration and the beamforming type.

In some examples of the method, RUs, and non-transitory computer-readable medium described herein, the one or more parameters include a threshold quantity of channel information processing capabilities per symbol, a threshold quantity of channel information processing capabilities per slot, a maximum quantity of stored channel estimates supported by the RU, or any combination thereof.

In some examples of the method, RUs, and non-transitory computer-readable medium described herein, receiving the channel information reporting configuration may include operations, features, means, or instructions for receiving channel information measurements associated with a quantity of user equipment (UE) identifiers (IDs), where the quantity of UE IDs satisfies the threshold quantity of channel information processing capabilities per symbol, the threshold quantity of channel information processing capabilities per slot, the maximum quantity of stored channel estimates supported by the RU, or any combination thereof.

In some examples of the method, RUs, and non-transitory computer-readable medium described herein, transmitting the capability report may include operations, features, means, or instructions for transmitting the capability report via management plane (M plane) signaling.

In some examples of the method, RUs, and non-transitory computer-readable medium described herein, the channel information capabilities may include section type 6 (ST6) capabilities, and receiving the channel information reporting configuration may include operations, features, means, or instructions for receiving one or more ST6 sections in accordance with the ST6 capabilities.

A method for wireless communication by a distributed unit (DU) is described. The method may include receiving a capability report including one or more parameters associated with channel information capabilities of an RU, where the channel information capabilities are associated with a beamforming type, transmitting a channel information reporting configuration in accordance with the one or more parameters, and receiving a channel information report in accordance with the channel information reporting configuration and the beamforming type.

A DU for wireless communication is described. The DU may include a processing system that includes processor circuitry and memory circuitry that stores code. The processing system may be configured to cause the DU to receive a capability report including one or more parameters associated with channel information capabilities of an RU, where the channel information capabilities are associated with a beamforming type, transmit a channel information reporting configuration in accordance with the one or more parameters, and receive a channel information report in accordance with the channel information reporting configuration and the beamforming type.

Another DU for wireless communication is described. The DU may include means for receiving a capability report including one or more parameters associated with channel information capabilities of an RU, where the channel information capabilities are associated with a beamforming type, means for transmitting a channel information reporting configuration in accordance with the one or more parameters, and means for receiving a channel information report in accordance with the channel information reporting configuration and the beamforming type.

A non-transitory computer-readable medium storing code for wireless communication is described. The code may include instructions executable by one or more processors to receive a capability report including one or more parameters associated with channel information capabilities of an RU, where the channel information capabilities are associated with a beamforming type, transmit a channel information reporting configuration in accordance with the one or more parameters, and receive a channel information report in accordance with the channel information reporting configuration and the beamforming type.

In some examples of the method, DUs, and non-transitory computer-readable medium described herein, the one or more parameters include a threshold quantity of channel information processing capabilities per symbol, a threshold quantity of channel information processing capabilities per slot, a maximum quantity of stored channel estimates supported by the RU, or any combination thereof.

In some examples of the method, DUs, and non-transitory computer-readable medium described herein, transmitting the channel information reporting configuration may include operations, features, means, or instructions for transmitting channel information measurements associated with a quantity of UE IDs, where the quantity of UE IDs satisfies the threshold quantity of channel information processing capabilities per symbol, the threshold quantity of channel information processing capabilities per slot, the maximum quantity of stored channel estimates supported by the RU, or any combination thereof.

In some examples of the method, DUs, and non-transitory computer-readable medium described herein, receiving the capability report may include operations, features, means, or instructions for receiving the capability report via M plane signaling.

In some examples of the method, DUs, and non-transitory computer-readable medium described herein, the channel information capabilities may include ST6 capabilities, and transmitting the channel information reporting configuration may include operations, features, means, or instructions for transmitting one or more ST6 sections in accordance with the ST6 capabilities.

### BRIEF DESCRIPTION OF THE DRAWINGS

FIG. 1 shows an example of a wireless communication system.

FIG. 2 shows an example of a network architecture that supports communication of channel information capabilities in open radio access networks.

FIG. 3 shows an example of a signaling configuration that supports communication of channel information capabilities in open radio access networks.

FIG. 4 shows an example of a process flow that supports communication of channel information capabilities in open radio access networks.

FIG. 5 shows a block diagram of a processing system that supports communication of channel information capabilities in open radio access networks.

FIG. 6 shows a diagram of a system including a device that supports communication of channel information capabilities in open radio access networks.

FIGS. 7 through 9 show flowcharts illustrating methods that support communication of channel information capabilities in open radio access networks.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, an open distributed unit (ODU) of an open RAN (O-RAN) may determine channel estimates based on a reference signal, and the ODU may send the channel estimates to an open radio unit (ORU) for processing (e.g., via section type 6 (ST6)). The ORU may process the channel estimates and calculate beam weights to be applied on data channels based on the channel estimates. However, the ORU may have a processing limit and a finite storage capacity that may limit capabilities of the ORU to process and store channel estimates, respectively. The ORU may communicate one or more generic capabilities (e.g., max-sections-per-symbol, max-sections-per-slot) to the ODU, but an O-RAN may lack explicit capability signaling from the ORU to the ODU to indicate channel information capabilities (e.g., ST6 capabilities) of the ORU. The lack of explicit capability signaling to indicate channel information capabilities of the ORU may lead the ODU to send a quantity of channel estimates to the ORU that exceeds the channel information capabilities of the ORU, overwhelming the ORU and impairing beam management.

Aspects of the subject matter described in this disclosure relate to communication of channel information capabilities in O-RANs. For example, an ORU may transmit, to an ODU, a capability report including one or more parameters associated with channel information capabilities of the ORU, where the channel information capabilities may be associated with a beamforming type. The ORU may receive, from the ODU, a channel information reporting configuration in accordance with the one or more parameters. The ORU may transmit a channel information report to the ODU in accordance with the channel information reporting configuration and the beamforming type.

Particular aspects of the subject matter described in this disclosure can be implemented to realize one or more of the following potential advantages. In some examples, by supporting communication of channel information capabilities of an ORU, the described techniques can be used to improve memory management, reliability of ORU performance, and user equipment (UE) identifier (ID) usage and prevent breaching of a storage capacity of the ORU.

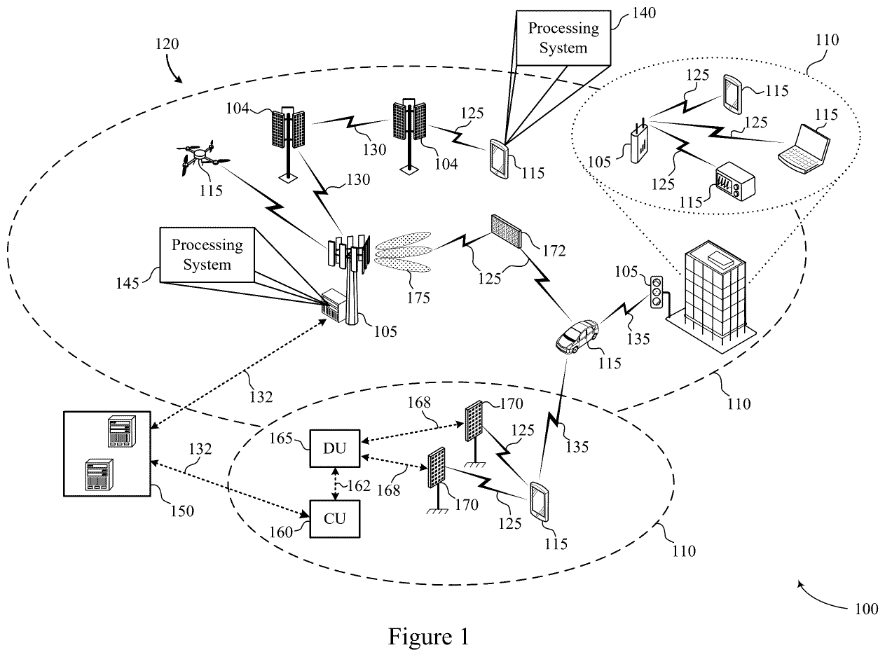

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an O-RAN, or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for communication of channel information capabilities in O-RANs. For example, a UE 115 may include a processing system 140, and a network entity 105 may include a processing system 145, each of which may be configured to cause the respective device to perform (such as being configured as means for performing) one or more of the described operations. In some cases, an RU 170 may transmit, to a DU 165, a capability report including one or more parameters associated with channel information capabilities of the RU 170, where the channel information capabilities are associated with a beamforming type. The RU 170 may receive, from the DU 165, a channel information reporting configuration in accordance with the one or more parameters. The RU 170 may transmit a channel information report to the DU 165 in accordance with the channel information reporting configuration and the beamforming type.

By configuring a processing system 140, a processing system 145, or a combination thereof in accordance with the described techniques, the wireless communication system 100 (such as the RAN 120) may support improved memory management, improved reliability of performance of RUs 170, and improved UE ID usage.

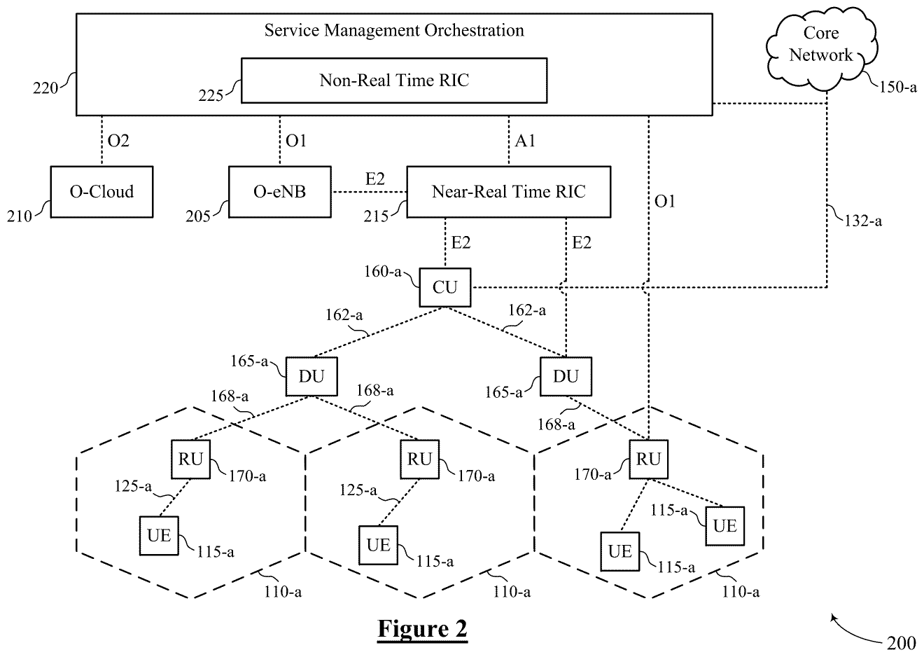

FIG. 2 shows an example of an architecture 200 that supports communication of channel information capabilities in O-RANs. The architecture 200 (such as a network architecture, a disaggregated base station architecture, a disaggregated RAN architecture) illustrates an example for implementing one or more aspects of a communication system 100 (such as a RAN 120), and may include one or more of a CU 160-a, a DU 165-a, and an RU 170-a.

In the example of architecture 200, a CU 160-a may communicate directly with a core network 150-a via a backhaul link 132-a, or indirectly with the core network 150-a through one or more disaggregated network entities 105. A CU 160-a may be connected with a DU 165-a via a midhaul link 162-a (such as an F1, F1c, or F1u interface), and a DU 165-a may be connected with an RU 170-a via fronthaul communication link 168-a (such as an open fronthaul (FH) interface). The RUs 170-a may be associated with respective coverage areas 110-a and may communicate with UEs 115-a via one or more communication links 125-a. A UE 115-a may be served by one or more of an RU 170-a, and multiples of an RU 170-a serving a UE 115-a may be associated with one or more of a DU 165-a.

A split of functionality between one or more of a CU 160-a, a DU 165-a, and an RU 170-a is flexible and may support different functionalities depending on which functions (such as network layer functions, protocol layer functions, baseband functions, RF functions, or combination thereof) are performed at the various entities. For example, a functional split of a protocol stack may be employed such that a CU 160-a, a DU 165-a, and an RU 170-a may each support one or more different layers of the protocol stack. Additionally, or alternatively, a functional split of a protocol stack may be within a protocol layer, such that some functions for a protocol layer are performed by one of a CU 160-a, a DU 165-a, or an RU 170-a, and some other functions of the protocol layer are performed by a different one of the CU 160-a, the DU 165-a, or the RU 170-a.

A CU 160-a may host upper protocol layer (such as layer 3 (L3), layer 2 (L2)) functionality and signaling (such as RRC, SDAP, PDCP). A CU 160-a may be functionally split into CU control plane (CU-CP) and CU user plane (CU-UP) functions. A CU 160-a may be logically split into one or more CU-UP units and one or more CU-CP units. A CU-UP unit may communicate bidirectionally with the CU-CP unit via an interface (such as an E1 interface). A CU 160-a may be connected with one or more of a DU 165-a, one or more of an RU 170-a, or a combination thereof. DUs 165-a, RUs 170-a, or both may host lower protocol layers, which may include layer 1 (L1) (such as PHY layer) or L2 (such as RLC layer, MAC layer) functionality and signaling, and each may be at least partially controlled by a CU 160-a. A DU 165-a may support one or multiple different cells (such as via one or more of an RU 170-a).

The architecture 200 may include a Service Management and Orchestration (SMO) framework (such as implementing an SMO 220) configured to support RAN deployment and provisioning of non-virtualized and virtualized network entities 105. The architecture 200 also may include a RAN Intelligent Controller (RIC), types of which may include Near-Real Time (RT) or Non-RT. In some cases, a network entity 105 (such as a CU 160-a, a DU 165-a) may communicate with a Near-RT RIC 215 via an E2 link, or a Non-RT RIC 225 associated with SMO 220, or both. An RU 170-a also may be referred to as a radio head, a smart radio head, a remote radio head (RRH), a remote radio unit (RRU), or a transmission/reception point (TRP). One or more components of a disaggregated RAN architecture may be co-located, or may be located in distributed (such as separate physical) locations. One or more network entities 105 of a disaggregated RAN architecture may be implemented as virtual units (such as a virtual CU (VCU), a virtual DU (VDU), a virtual RU (VRU)) and provide network function virtualization, which may be supported by an open-cloud (O-Cloud) platform (such as an O-Cloud 210). For example, functionality of a network entity 105 may be implemented in an O-eNB 205.

For non-virtualized network entities, the SMO 220 may be configured to support the deployment of dedicated physical resources for RAN coverage requirements which may be managed via an operations and maintenance interface (such as an O1 interface). For virtualized network entities, the SMO 220 may be configured to interact with a cloud computing platform, such as an open-cloud (O-Cloud) platform (such as O-Cloud 210), to perform network entity life cycle management (such as to instantiate virtualized network entities) via a cloud computing platform interface (such as an O2 interface). Such virtualized network entities can include, but are not limited to, CUs 160-a, DUs 165-a, RUs 170-a, and Near-RT RICs 215. In some implementations, the SMO 220 may communicate with components configured in accordance with a 4G RAN (such as via an O1 interface). Additionally, or alternatively, in some implementations, the SMO 220 may communicate directly with one or more RUs 170-a via an O1 interface. The SMO 220 also may include a Non-RT RIC 225 configured to support functionality of the SMO 220.

The Non-RT RIC 225 may include a logical function that enables non-real time control and optimization of RAN elements and resources, Artificial Intelligence (AI) or Machine Learning (ML) workflows including model training and updates, or policy-based guidance of applications/features in the Near-RT RIC 215. The Non-RT RIC 225 may communicate with (such as via an A1 interface) the Near-RT RIC 215. The Near-RT RIC 215 may include a logical function that enables near-real time control and optimization of RAN elements and resources via data collection and actions over an interface (such as via an E2 interface) connecting one or more CUs, one or more DUs, or both, as well as an O-RAN-enabled eNB (O-eNB) (such as an O-eNB 205), with the Near-RT RIC 215.

In some examples, to generate AI/ML models to be deployed in the Near-RT RIC 215, the Non-RT RIC 225 may receive parameters or external enrichment information from external servers. Such information may be utilized by the Near-RT RIC 215 and may be received at the SMO 220 or the Non-RT RIC 225 from non-network data sources or from network functions. In some examples, the Non-RT RIC 225 or the Near-RT RIC 215 may be configured to tune RAN behavior or performance. For example, the Non-RT RIC 225 may monitor long-term trends and patterns for performance and employ AI or ML models to perform corrective actions through the SMO 220 (such as a reconfiguration via O1) or via generation of RAN management policies (such as A1 policies).

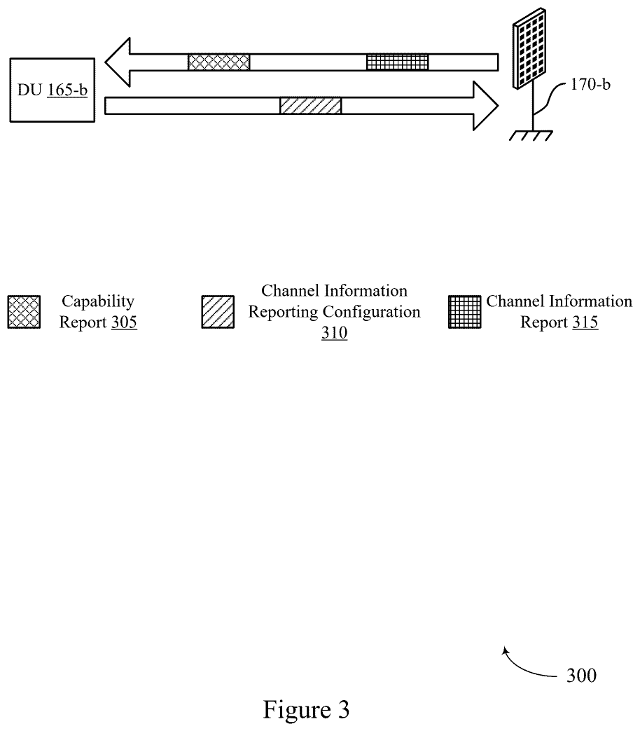

FIG. 3 shows an example of a signaling configuration 300 that supports communication of channel information capabilities in O-RANs. In some examples, the signaling configuration 300 may implement, or be implemented by, aspects of the wireless communication system 100 and the architecture 200. For example, the signaling configuration 300 may include a DU 165-b and an RU 170-b, which may be examples of corresponding devices as described with reference to FIG. 1 and FIG. 2.

In some examples of the signaling configuration 300, the DU 165-b (e.g., an ODU) may determine channel information measurements (e.g., channel estimates) based on a reference signal (e.g., an SRS) and send the channel information measurements to the RU 170-b (e.g., an ORU). The RU 170-b may process the channel information measurements incoming from the DU 165-b and calculate beam weights to be applied to associated data channels based on the channel information measurements. The RU 170-b may also store one or more channel information measurements for a channel until the RU 170-b receives new channel information measurements for the channel. For example, the DU 165-b may transmit an ST6 to the RU 170-b for PRBs and transmissions. The ST6 may include a quantity of channel information measurements, which may be a product of a quantity of PRBs, a quantity of transmissions, and a quantity of in-band and quadrature (IQ) samples. Accordingly, the quantity of channel information measurements and a data transfer speed of the ST6 may be relatively high for each reference signal.

However, the RU 170-b may have a processing limit for channel information measurements (e.g., a processing limit for ST6, which may vary by vendor or by RU 170), which may impact heavy incoming traffic. That is, the RU 170-b may be capable of processing a limited quantity of ST6 sections per slot or per symbol. The RU 170-b may also have a finite storage capacity, which may limit a capability of the RU 170-b to store channel information measurements incoming from the DU 165-b. The RU 170-bmay indicate a quantity of capabilities (e.g., max-sections-per-symbols, max-sections-per-slot) to the DU 165-b via management plane (M plane) signaling, but these capabilities may be generic to a plurality of section types (e.g., not specific to heavily loaded ST6) and may not define an actual load that the RU 170-b may intake per section type. For instance, section types other than ST6 (e.g., section type 1 (ST1), section type 3 (ST3), section type 5 (ST5)) may be relatively light sections for which the RU 170-b may use a lower processing time and refrain from storing data. The quantity of generic capabilities may be reflective of the section types other than ST6, but capabilities of the RU 170-b for channel information (e.g., ST6 sections) may be lower than the generic capabilities due to the different qualities of ST6 (e.g., storage of channel estimates/ST6 sections, longer processing time due to a high volume of data).

Without signaling to indicate explicit channel information capabilities, the DU 165-b may send more channel information measurements (e.g., channel estimates) to the RU 170-b than the RU 170-b can process and store, overwhelming the RU 170-b. For instance, the DU 165-b may send the RU 170-b a quantity of ST6 sections that exceed a processing capability of the RU 170-b for processing ST6 sections, but a total quantity of control plane (C plane) sections (e.g., of any section type, including the quantity of ST6 sections) may still be less than the generic capabilities of the RU 170-b. Consequently, the RU 170-b may crash, and communications between the DU 165-b and the RU 170-b may experience unpredictable behavior and a relatively high block error rate (BLER). In cases of RU beamforming (RU-BF), the DU 165-b may be similarly overwhelmed with channel information measurements (e.g., ST6) incoming from the RU 170-b.

Accordingly, the techniques described herein support communication of explicit channel information capabilities between the RU 170-b and the DU 165-b. The RU 170-b may transmit a capability report 305 including one or more parameters associated with channel information capabilities to the DU 165-b. For example, the RU 170-b may transmit the capability report 305 to the DU 165-b via M plane signaling (e.g., the channel information capabilities may be M plane capabilities). In some aspects, the channel information capabilities may be associated with a beamforming type (e.g., SRS beamforming, CSI-RS beamforming, or both). In some examples, the channel information capabilities may be ST6 capabilities.

The one or more parameters may include a threshold (e.g., maximum) quantity of channel information processing capabilities per symbol. For instance, the threshold quantity of channel information processing capabilities per symbol may indicate how many UE IDs the RU 170-b may process per symbol. In some examples, the threshold quantity of channel information processing capabilities per symbol may be a quantity of ST6 sections that the RU 170-b may process per symbol (e.g., max-st6sections-per-symbol). In some aspects, the threshold quantity of channel information processing capabilities per symbol may be expressed in the capability report 305 as an unsigned 16-bit integer (e.g., unit 16).

In some cases, the one or more parameters may include a threshold (e.g., maximum) quantity of channel information processing capabilities per slot. For instance, the threshold quantity of channel information processing capabilities per slot may indicate how many UE IDs the RU 170-b may process per slot. In some examples, the threshold quantity of channel information processing capabilities per slot may be a quantity of ST6 sections that the RU 170-b may process per slot (e.g., max-st6sections-per-slot). In some aspects, the threshold quantity of channel information processing capabilities per slot may be expressed in the capability report 305 as an unsigned 16-bit integer (e.g., unit16).

Additionally, or alternatively, the one or more parameters may include a maximum quantity of stored channel estimates supported by the RU 170-b. The maximum quantity of stored channel estimates may be based on a finite memory capacity of the RU 170-b. For example, the maximum quantity of stored channel estimates may be an overall capacity of the RU 170-b rather than a per symbol or per slot capability. In some aspects, the maximum quantity of stored channel estimates may indicate how many UE IDs (e.g., max-active-st6ueids-supported) for which the RU 170-b may store channel estimates at one time. In some cases, the maximum quantity of stored channel estimates may be expressed in the capability report 305 as an unsigned 16-bit integer (e.g., unit 16).

After receiving the capability report 305, the DU 165-b may send a channel information reporting configuration 310 to the RU 170-b in accordance with the one or more parameters. That is, the DU 165-b may be able to determine how many channel information measurements (e.g., or UE IDs, ST6 sections, etc.) the DU 165-b may send to the RU 170-b per symbol or per slot based on the one or more parameters of the capability report 305. Similarly, the DU 165-b may be able to determine how many channel information measurements the RU 170-b may store at one time, and the DU 165-b may refrain from sending the DU 165-b more channel information measurements (e.g., in the channel information reporting configuration 310) beyond the maximum quantity of stored channel estimates supported by the RU 170-b. The DU 165-b may accordingly reuse older channel information estimates (e.g., older UE IDs) for new UEs 115 entering a component carrier (CC) to improve UE ID usage and avoid breaching the storage capacity of the RU 170-b.

For example, the channel information reporting configuration 310 may include one or more channel information measurements associated with a quantity of UE IDs that are to be processed and/or stored by the RU 170-b. The quantity of UE IDs may satisfy the threshold quantity of channel information processing capabilities per symbol, the threshold quantity of channel information processing capabilities per slot, the maximum quantity of stored channel estimates supported by the RU 170-b, or any combination thereof. In some examples, the reporting configuration may be an ST6 including a quantity of ST6 sections that are within the ST6 capabilities of the RU 170-b.

The RU 170-b may receive the channel information reporting configuration 310 in accordance with the one or more parameters. The RU 170-b may be able to process the one or more channel information measurements based on the quantity of UE IDs satisfying the threshold quantity of channel information processing capabilities per symbol, the threshold quantity of channel information processing capabilities per slot, or both. In some aspects, the one or more channel measurements of the channel information reporting configuration 310 satisfying the channel information processing capabilities of the RU 170-b may improve memory management and reliability of performance of the RU 170-b. Likewise, the RU 170-b may be able to store the one or more channel information measurements based on the quantity of UE IDs satisfying the maximum quantity of stored channel estimates supported by the RU 170-b.

The RU 170-b may transmit a channel information report 315 in accordance with the channel information reporting configuration 310 and the beamforming type. For instance, the RU 170-b may transmit an SRS derivatives report (e.g., an ST6) to the DU 165-b based on processing the one or more channel information measurements included in the channel information reporting configuration 310. In some cases, the channel information report 315 may include the one or more processed channel information measurements, an indication of one or more beam weights to be applied to one or more data channels, or a combination thereof.

The DU 165-b and the RU 170-b exchanging explicit channel information capabilities and exchanging the channel information reporting configuration 310 and the channel information report 315 in accordance with channel information capabilities may be beneficial for channel information beamforming (CIBF) and RU-BF (e.g., for different vendor interoperability). For instance, channel information capabilities of various RUs 170 may vary, and capability reports 305 may allow DUs 165 to send each RU 170 channel information measurements for processing and/or storage in accordance with channel information capabilities of the particular RU 170. A DU 165 sending a particular RU 170 channel information measurements in accordance with the channel information capabilities of the particular RU 170 may reduce a BLER, prevent crashing and unpredictable behavior of the RU 170, improve UE ID usage, improve memory management, and improve overall performance of the RU 170.

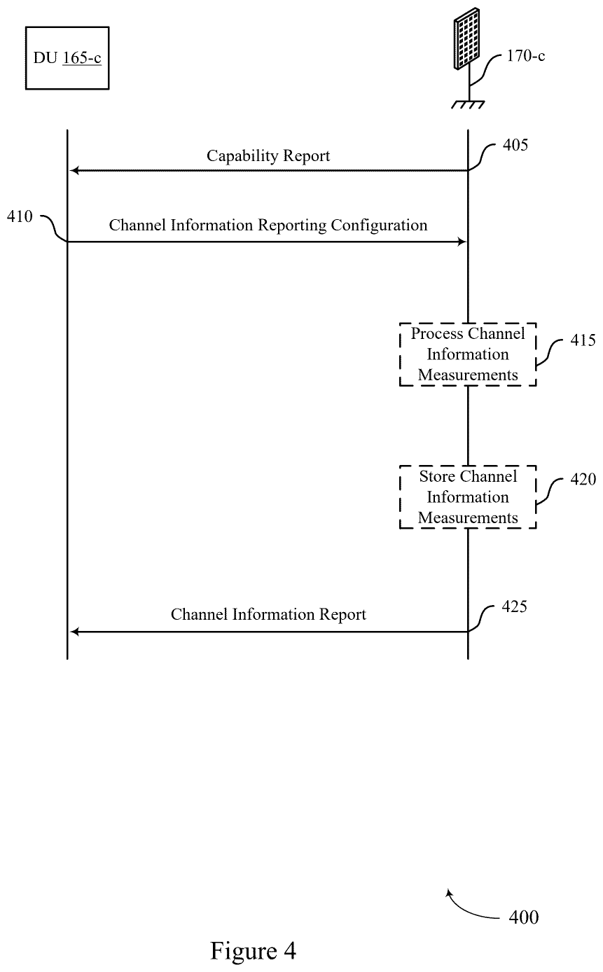

FIG. 4 shows an example of a process flow 400 that supports communication of channel information capabilities in O-RANs in accordance with one or more aspects of the present disclosure. In some aspects, the process flow 400 may implement or be implemented to realize aspects of the wireless communication system 100, the architecture 200, and the signaling configuration 300. For example, the process flow 400 may include a DU 165-c and an RU 170-c, which may be examples of the DU 165-b and the RU 170-b, respectively, as illustrated in FIG. 3.

In the following description of the process flow 400, the operations between the DU 165-b and the RU 170-b may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may actually occur at the same time.

At 405, the RU 170-c may transmit, and the DU 165-c may receive, a capability report including one or more parameters associated with channel information capabilities to the DU 165-b. In some aspects, the channel information capabilities may be associated with a beamforming type, for example SRS beamforming, CSI-RS beamforming, or both. The one or more parameters may include a threshold quantity of channel information processing capabilities (e.g., a quantity of UE IDs or ST6 sections) per symbol, a threshold quantity of channel information processing capabilities per slot, a maximum quantity of stored channel estimates supported by the RU 170-c, or any combination thereof. The RU 170-c may, in some cases, transmit the capability report via M plane signaling. In some examples, the channel information capabilities may be ST6 capabilities.

At 410, the DU 165-c may transmit, and the RU 170-c may receive, a channel information reporting configuration in accordance with the one or more parameters. For example, the channel information reporting configuration may include channel information measurements associated with a quantity of UE IDs, where the quantity of UE IDs satisfies the threshold quantity of channel information processing capabilities per symbol, the threshold quantity of channel information processing capabilities per slot, the maximum quantity of stored channel estimates supported by the RU 170-c, or any combination thereof. In some examples, the channel information reporting configuration may include one or more ST6 sections in accordance with ST6 capabilities of the RU 170-c indicated in the capability report.

At 415, the RU 170-c may, in some cases, process one or more channel information measurements included in the channel information reporting configuration. For instance, the RU 170-c may process the one or more channel information measurements based on the one or more channel information measurements satisfying the one or more parameters (e.g., the threshold quantity of channel information processing capabilities per symbol, the threshold quantity of channel information processing capabilities per slot, or both). In some cases, processing the one or more channel information measurements may include calculating one or more beam weights based on the one or more channel information measurements, where the one or more beam weights are to be applied to one or more data channels associated with the one or more channel information measurements.

At 420, the RU 170-c may, in some examples, store the one or more channel information measurements included in the channel information reporting configuration. For instance, the RU 170-c may store the one or more channel information measurements based on a quantity of UE IDs associated with the one or more channel information measurements satisfying the maximum quantity of stored channel estimates supported by the RU 170-c. In some aspects, the maximum quantity of stored channel estimates may be based on a finite memory capacity of the RU 170-c, and the RU 170-c may store the one or more channel information measurements based on the one or more channel information measurements not exceeding the finite memory capacity.

At 425, the RU 170-c may transmit a channel information report to the DU 165-c in accordance with the channel information reporting configuration and the beamforming type. For instance, the RU 170-c may transmit an SRS derivatives report (e.g., an ST6) to the DU 165-c based on processing the one or more channel information measurements included in the channel information reporting configuration. In some cases, the channel information report may include the one or more processed channel information measurements, an indication of one or more beam weights to be applied to one or more data channels, or a combination thereof.

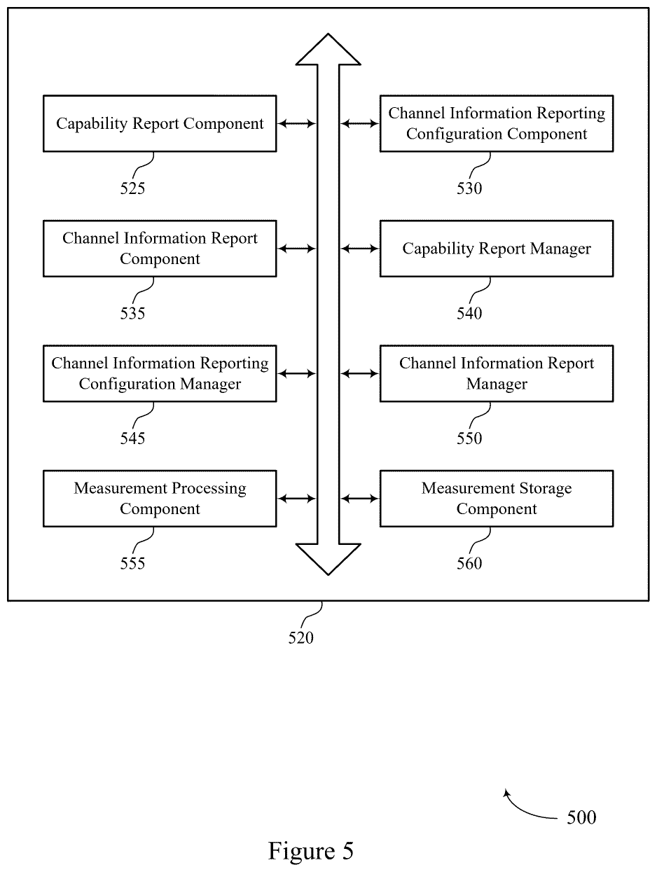

FIG. 5 shows an example 500 of a processing system 520 that supports communication of channel information capabilities in O-RANs. A processing system 520 may be an example of a processing system 145 (such as network entity 105) and may include a capability report component 525, a channel information reporting configuration component 530, a channel information report component 535, a capability report manager 540, a channel information reporting configuration manager 545, a channel information report manager 550, a measurement processing component 555, a measurement storage component 560, or any combination thereof. A processing system 520, or various component thereof, may be an example of means for performing (such as a means for causing a network entity 105 to perform) various techniques described herein.

The capability report component 525 may be configured to cause the network entity 105 to transmit a capability report including one or more parameters associated with channel information capabilities, where the channel information capabilities are associated with a beamforming type. The channel information reporting configuration component 530 may be configured to cause the network entity 105 to receive a channel information reporting configuration in accordance with the one or more parameters. The channel information report component 535 may be configured to cause the network entity 105 to transmit a channel information report in accordance with the channel information reporting configuration and the beamforming type.

In some examples, the one or more parameters include a threshold quantity of channel information processing capabilities per symbol, a threshold quantity of channel information processing capabilities per slot, a maximum quantity of stored channel estimates supported by the RU, or any combination thereof.

In some examples, to support receiving the channel information reporting configuration, the channel information reporting configuration component 530 may be configured to cause the network entity 105 to receive channel information measurements associated with a quantity of UE IDs, where the quantity of UE IDs satisfies the threshold quantity of channel information processing capabilities per symbol, the threshold quantity of channel information processing capabilities per slot, the maximum quantity of stored channel estimates supported by the RU, or any combination thereof.

In some examples, the measurement storage component 560 may be configured to cause the network entity 105 to store the channel information measurements at the RU based on the quantity of UE IDs satisfying the maximum quantity of stored channel estimates supported by the RU.

In some examples, to support transmitting the capability report, the capability report component 525 may be configured to cause the network entity 105 to transmit the capability report via M plane signaling.

In some examples, the beamforming type includes SRS beamforming, CSI-RS beamforming, or both.

In some examples, the channel information reporting configuration includes one or more channel information measurements satisfying the one or more parameters, and the measurement processing component 555 may be configured to cause the network entity 105 to process the one or more channel information measurements based on the one or more channel information measurements satisfying the one or more parameters, where transmitting the channel information report is based on the processing.

In some examples, the channel information capabilities may include ST6 capabilities, and to support receiving the channel information reporting configuration, the channel information reporting configuration component 530 may be configured to cause the network entity 105 to receive one or more ST6 sections in accordance with the ST6 capabilities.

Additionally, or alternatively, the capability report manager 540 may be configured to cause the network entity 105 to receive a capability report including one or more parameters associated with channel information capabilities of an RU, where the channel information capabilities are associated with a beamforming type. The channel information reporting configuration manager 545 may be configured to cause the network entity 105 to transmit a channel information reporting configuration in accordance with the one or more parameters. The channel information report manager 550 may be configured to cause the network entity 105 to receive a channel information report in accordance with the channel information reporting configuration and the beamforming type.

In some examples, the one or more parameters include a threshold quantity of channel information processing capabilities per symbol, a threshold quantity of channel information processing capabilities per slot, a maximum quantity of stored channel estimates supported by the RU, or any combination thereof.

In some examples, to support transmitting the channel information reporting configuration, the channel information reporting configuration manager 545 may be configured to cause the network entity 105 to transmit channel information measurements associated with a quantity of UE IDs, where the quantity of UE IDs satisfies the threshold quantity of channel information processing capabilities per symbol, the threshold quantity of channel information processing capabilities per slot, the maximum quantity of stored channel estimates supported by the RU, or any combination thereof.

In some examples, to support receiving the capability report, the capability report manager 540 may be configured to cause the network entity 105 to receive the capability report via M plane signaling.

In some examples, the beamforming type includes SRS beamforming, CSI-RS beamforming, or both.

In some examples, the channel information capabilities may include ST6 capabilities, and to support transmitting the channel information reporting configuration, the channel information reporting configuration manager 545 may be configured to cause the network entity 105 to transmit one or more ST6 sections in accordance with the ST6 capabilities.

A processing system 520 may include or be an example of one or more chips, SoCs, chipsets, packages, components, or devices that individually or collectively constitute or include a processing system. A processing system 520 may interface with other components of a network entity 105. For example, operations described with reference to a processing system 520, or various components thereof, may be performed by or with other such components, including a receiver, a transmitter, a transceiver, a modem, a user interface, a modulator/demodulator, an encoder/decoder, or any combination thereof (such as of the processing system 520, coupled with the processing system 520, of a network entity 105). Operations described herein with reference to the processing system 520, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 520 for operation in a processing system 520 as described herein, the processing system 520 may support techniques for improved communication reliability, reduced latency, improved user experience related to reduced processing, more efficient utilization of communication resources, improved coordination between devices, and improved utilization of processing capability.

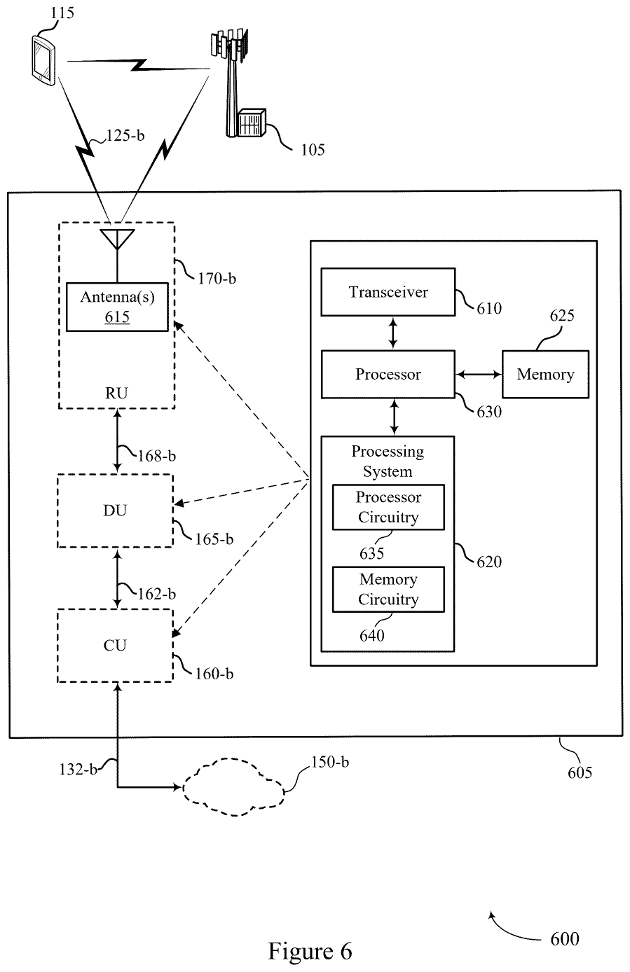

FIG. 6 shows an example of a system 600 including a device 605 that supports communication of channel information capabilities in O-RANs. The device 605 may communicate (such as via one or more wired interfaces or one or more wireless interfaces) with other network devices or network equipment such as a core network 150-b, other network entities 105, UEs 115, or any combination thereof. The device 605 may include components for transmitting and receiving communication, which may include a processing system 620, a transceiver 610, antenna(s) 615, a memory 625, and a processor 630. Components of the device 605 may be coupled (such as operatively, communicatively, functionally, electronically, electrically, in electronic communication) via one or more interfaces.

The transceiver 610 may communicate bi-directionally with another transceiver via wired or wireless links, and may support transmission operations, reception operations, or both, as described herein. The transceiver 610 may include a modem to modulate and demodulate signals, to provide the modulated signals for transmission (such as via antenna(s) 615, via a wired interface), and to demodulate received signals (such as received via antenna(s) 615, received via a wired interface). The transceiver 610 may be operable to support communication via one or more communication links (such as a communication link 125-b, a backhaul link 132-b, a midhaul link 162-b, fronthaul link 168-b).

The processor 630 may be a general-purpose processing component that supports various operations (such as applications) of the device 605. The memory 625 may be a general-purpose storage component that stores code executable by the processor 630. Such code may include instructions that, when executed by the processor 630, cause the device 605 to perform various functions (such as to support an application of the device 605).

For examples in which the device 605 is a network entity 105 in a disaggregated architecture, one or more components of the device 605 may be located at one or more of a CU 160-b, a DU 165-b, or an RU 170-b, one or more of which may include aspects of the processing system 620, the processor 630, the memory 625, or the transceiver 610. Functions of the device 605 may be performed at different components or an operation may be divided between different components (such as different functions being supported by aspects of the CU 160-b, the DU 165-b, or the RU 170-b, the transceiver 610, the processor 630, the memory 625, the processing system 620, or any combination thereof). For example, the processing system 620 may be a component of one or more of the CU 160-b, the DU 165-b, or the RU 170-b. In some examples, interfaces between components of device 605 (such as CU 160-b, DU 165-b, RU 170-b) may support communication at a protocol layer or between protocol layers of a protocol stack.

In some examples, the processing system 620 may manage aspects of communication with the core network 150-b (such as via a backhaul link 132). For example, the processing system 620 may manage the transfer of data communication for UEs 115 with a gateway of the core network 150-b. In some examples, the processing system 620 may manage communication with one or more other network entities 105 and may include a controller or scheduler for controlling communication with UEs 115 (such as in cooperation with the one or more other network entities 105). In some examples, the processing system 620 may support an interface (such as X2 interface, Xn interface) to provide communication between network entities 105.

The processing system 620 may be an example of a processing system 145 or a processing system 520. For example, the processing system 620 may include processor circuitry 635 and memory circuitry 640 that stores code, and the processing system 620 may be configured to cause the device 605 to perform operations that support communication of channel information capabilities in O-RANs. Although the processing system 620 is illustrated as a separate component, which may involve a separate chip, chipset, or other module, in some implementations, one or more functions described with reference to the processing system 620 may be supported by or performed by a transceiver 610, antenna(s) 615, a processor 630, memory 625, or any combination thereof, such that a processing system 620 may include one or more of a transceiver 610, antenna(s) 615, a processor 630, memory 625, or any combination thereof. Further, processor circuitry 635 and memory circuitry 640 each may be implemented at the device 605 in accordance with an aggregated architecture, or the processor circuitry 635 and the memory circuitry 640 may be implemented at one or more of a CU 160-b, a DU 165-b, or an RU 170-b in accordance with a disaggregated architecture.

By including or configuring the processing system 620 for operation in the device 605 as described herein, may support techniques for improved communication reliability, reduced latency, improved user experience related to reduced processing, more efficient utilization of communication resources, improved coordination between devices, and improved utilization of processing capability.

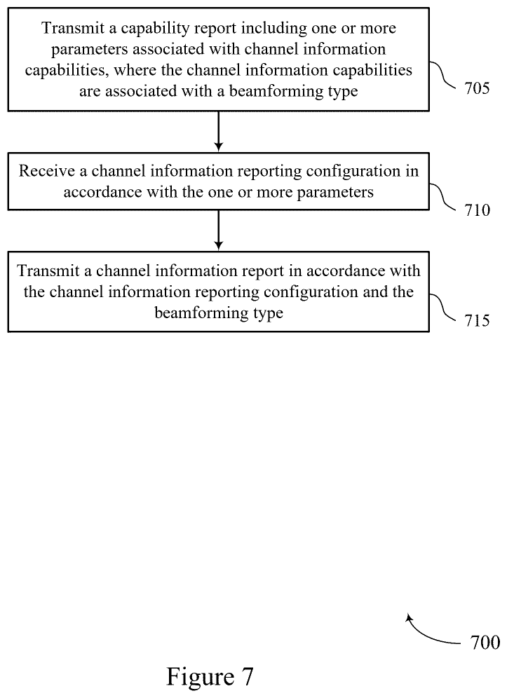

FIG. 7 shows an example of a method 700 that supports communication of channel information capabilities in O-RANs. Operations of the method 700 may be performed by a network entity 105 or its components (such as using a processing system configured to cause the network entity to perform one or more operations) as described herein.

At 705, the method may include transmitting a capability report including one or more parameters associated with channel information capabilities, where the channel information capabilities are associated with a beamforming type. In some examples, aspects of the operations of 705 may be performed by a capability report component 525.

At 710, the method may include receiving a channel information reporting configuration in accordance with the one or more parameters. In some examples, aspects of the operations of 710 may be performed by a channel information reporting configuration component 530.

At 715, the method may include transmitting a channel information report in accordance with the channel information reporting configuration and the beamforming type. In some examples, aspects of the operations of 715 may be performed by a channel information report component 535.

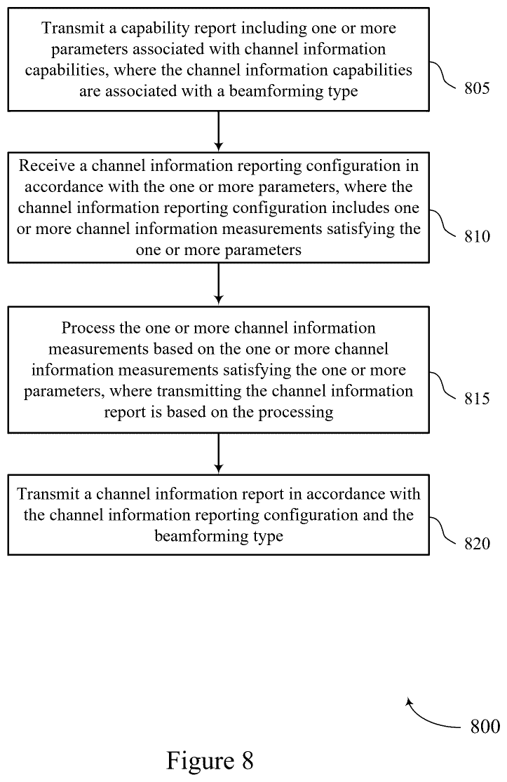

FIG. 8 shows an example of a method 800 that supports communication of channel information capabilities in O-RANs. Operations of the method 800 may be performed by a network entity 105 or its components (such as using a processing system configured to cause the network entity to perform one or more operations) as described herein.

At 805, the method may include transmitting a capability report including one or more parameters associated with channel information capabilities, where the channel information capabilities are associated with a beamforming type. In some examples, aspects of the operations of 805 may be performed by a capability report component 525.

At 810, the method may include receiving a channel information reporting configuration in accordance with the one or more parameters, where the channel information reporting configuration includes one or more channel information measurements satisfying the one or more parameters. In some examples, aspects of the operations of 810 may be performed by a channel information reporting configuration component 530.

At 815, the method may include processing the one or more channel information measurements based on the one or more channel information measurements satisfying the one or more parameters, where transmitting the channel information report is based on the processing. In some examples, aspects of the operations of 815 may be performed by a measurement processing component 555.

At 820, the method may include transmitting a channel information report in accordance with the channel information reporting configuration and the beamforming type. In some examples, aspects of the operations of 820 may be performed by a channel information report component 535.

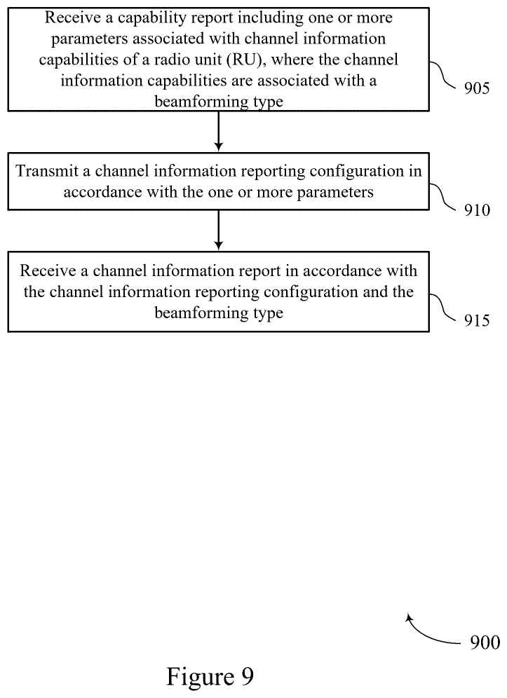

FIG. 9 shows an example of a method 900 that supports communication of channel information capabilities in O-RANs. Operations of the method 900 may be performed by a network entity 105 or its components (such as using a processing system configured to cause the network entity to perform one or more operations) as described herein.

At 905, the method may include receiving a capability report including one or more parameters associated with channel information capabilities of an RU, where the channel information capabilities are associated with a beamforming type. In some examples, aspects of the operations of 905 may be performed by a capability report manager 540.

At 910, the method may include transmitting a channel information reporting configuration in accordance with the one or more parameters. In some examples, aspects of the operations of 910 may be performed by a channel information reporting configuration manager 545.

At 915, the method may include receiving a channel information report in accordance with the channel information reporting configuration and the beamforming type. In some examples, aspects of the operations of 915 may be performed by a channel information report manager 550.

Implementation examples are described in the following numbered clauses:

Aspect 1: A method for wireless communication by an RU, comprising: transmitting a capability report comprising one or more parameters associated with channel information capabilities, wherein the channel information capabilities are associated with a beamforming type; receiving a channel information reporting configuration in accordance with the one or more parameters; and transmitting a channel information report in accordance with the channel information reporting configuration and the beamforming type.

Aspect 2: The method of aspect 1, wherein the one or more parameters comprise a threshold quantity of channel information processing capabilities per symbol, a threshold quantity of channel information processing capabilities per slot, a maximum quantity of stored channel estimates supported by the RU, or any combination thereof.

Aspect 3: The method of aspect 2, wherein receiving the channel information reporting configuration comprises: receiving channel information measurements associated with a quantity of UE IDs, wherein the quantity of UE IDs satisfies the threshold quantity of channel information processing capabilities per symbol, the threshold quantity of channel information processing capabilities per slot, the maximum quantity of stored channel estimates supported by the RU, or any combination thereof.

Aspect 4: The method of aspect 3, further comprising: storing the channel information measurements at the RU based at least in part on the quantity of UE IDs satisfying the maximum quantity of stored channel estimates supported by the RU.

Aspect 5: The method of any of aspects 1 through 4, wherein transmitting the capability report comprises: transmitting the capability report via M plane signaling.

Aspect 6: The method of any of aspects 1 through 5, wherein the beamforming type comprises SRS beamforming, CSI-RS beamforming, or both.

Aspect 7: The method of any of aspects 1 through 6, wherein the channel information reporting configuration comprises one or more channel information measurements satisfying the one or more parameters, the method further comprising: processing the one or more channel information measurements based at least in part on the one or more channel information measurements satisfying the one or more parameters, wherein transmitting the channel information report is based at least in part on the processing.

Aspect 8: The method of any of aspects 1 through 7, wherein the channel information capabilities comprise ST6 capabilities, and wherein receiving the channel information reporting configuration comprises: receiving one or more ST6 sections in accordance with the ST6 capabilities.

Aspect 9: A method for wireless communication by a DU, comprising: receiving a capability report comprising one or more parameters associated with channel information capabilities of an RU, wherein the channel information capabilities are associated with a beamforming type; transmitting a channel information reporting configuration in accordance with the one or more parameters; and receiving a channel information report in accordance with the channel information reporting configuration and the beamforming type.

Aspect 10: The method of aspect 9, wherein the one or more parameters comprise a threshold quantity of channel information processing capabilities per symbol, a threshold quantity of channel information processing capabilities per slot, a maximum quantity of stored channel estimates supported by the RU, or any combination thereof.

Aspect 11: The method of aspect 10, wherein transmitting the channel information reporting configuration comprises: transmitting channel information measurements associated with a quantity of UE IDs, wherein the quantity of UE IDs satisfies the threshold quantity of channel information processing capabilities per symbol, the threshold quantity of channel information processing capabilities per slot, the maximum quantity of stored channel estimates supported by the RU, or any combination thereof.

Aspect 12: The method of any of aspects 9 through 11, wherein receiving the capability report comprises: receiving the capability report via M plane signaling.

Aspect 13: The method of any of aspects 9 through 12, wherein the beamforming type comprises SRS beamforming, CSI-RS beamforming, or both.

Aspect 14: The method of any of aspects 9 through 13, wherein the channel information capabilities comprise ST6 capabilities, and wherein transmitting the channel information reporting configuration comprises: transmitting one or more ST6 sections in accordance with the ST6 capabilities.

Aspect 15: An RU for wireless communication, comprising a processing system that includes processor circuitry and memory circuitry that stores code, the processing system configured to cause the RU to perform a method of any of aspects 1 through 8.

Aspect 16: An RU for wireless communication, comprising at least one means for performing a method of any of aspects 1 through 8.

Aspect 17: A non-transitory computer-readable medium storing code for wireless communication, the code comprising instructions executable by one or more processors to perform a method of any of aspects 1 through 8.

Aspect 18: A DU for wireless communication, comprising a processing system that includes processor circuitry and memory circuitry that stores code, the processing system configured to cause the DU to perform a method of any of aspects 9 through 14.

Aspect 19: A DU for wireless communication, comprising at least one means for performing a method of any of aspects 9 through 14.

Aspect 20: A non-transitory computer-readable medium storing code for wireless communication, the code comprising instructions executable by one or more processors to perform a method of any of aspects 9 through 14.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A radio unit (RU), comprising:
one or more memories storing processor-executable code; and
one or more processors coupled with the one or more memories and individually or collectively operable to execute the code to cause the RU to:
transmit a capability report comprising one or more parameters associated with channel information capabilities, wherein the channel information capabilities are associated with a beamforming type;
receive a channel information reporting configuration in accordance with the one or more parameters; and
transmit a channel information report in accordance with the channel information reporting configuration and the beamforming type.

2. The RU of claim 1, wherein the one or more parameters comprise a threshold quantity of channel information processing capabilities per symbol, a threshold quantity of channel information processing capabilities per slot, a maximum quantity of stored channel estimates supported by the RU, or any combination thereof.

3. The RU of claim 2, wherein, to receive the channel information reporting configuration, the one or more processors are individually or collectively operable to execute the code to cause the RU to:
receive channel information measurements associated with a quantity of user equipment identifiers, wherein the quantity of user equipment identifiers satisfies the threshold quantity of channel information processing capabilities per symbol, the threshold quantity of channel information processing capabilities per slot, the maximum quantity of stored channel estimates supported by the RU, or any combination thereof.

4. The RU of claim 3, wherein the one or more processors are individually or collectively further operable to execute the code to cause the RU to:
store the channel information measurements at the RU based at least in part on the quantity of user equipment identifiers satisfying the maximum quantity of stored channel estimates supported by the RU.

5. The RU of claim 1, wherein, to transmit the capability report, the one or more processors are individually or collectively operable to execute the code to cause the RU to:
transmit the capability report via management plane signaling.

6. The RU of claim 1, wherein the beamforming type comprises sounding reference signal beamforming, channel state information reference signal beamforming, or both.

7. The RU of claim 1, wherein the channel information reporting configuration comprises one or more channel information measurements satisfying the one or more parameters, and the one or more processors are individually or collectively further operable to execute the code to cause the RU to:
process the one or more channel information measurements based at least in part on the one or more channel information measurements satisfying the one or more parameters, wherein transmitting the channel information report is based at least in part on the processing.

8. The RU of claim 1, wherein the channel information capabilities comprise section type 6 capabilities, and wherein, to receive the channel information reporting configuration, the one or more processors are individually or collectively operable to execute the code to cause the RU to:
receive one or more section type 6 sections in accordance with the section type 6 capabilities.

9. A distributed unit (DU), comprising:
one or more memories storing processor-executable code; and
one or more processors coupled with the one or more memories and individually or collectively operable to execute the code to cause the DU to:
receive a capability report comprising one or more parameters associated with channel information capabilities of a radio unit (RU), wherein the channel information capabilities are associated with a beamforming type;
transmit a channel information reporting configuration in accordance with the one or more parameters; and
receive a channel information report in accordance with the channel information reporting configuration and the beamforming type.

10. The DU of claim 9, wherein the one or more parameters comprise a threshold quantity of channel information processing capabilities per symbol, a threshold quantity of channel information processing capabilities per slot, a maximum quantity of stored channel estimates supported by the RU, or any combination thereof.

11. The DU of claim 10, wherein, to transmit the channel information reporting configuration, the one or more processors are individually or collectively operable to execute the code to cause the DU to:
transmit channel information measurements associated with a quantity of user equipment identifiers, wherein the quantity of user equipment identifiers satisfies the threshold quantity of channel information processing capabilities per symbol, the threshold quantity of channel information processing capabilities per slot, the maximum quantity of stored channel estimates supported by the RU, or any combination thereof.

12. The DU of claim 9, wherein, to receive the capability report, the one or more processors are individually or collectively operable to execute the code to cause the DU to:
receive the capability report via management plane signaling.

13. The DU of claim 9, wherein the beamforming type comprises sounding reference signal beamforming, channel state information reference signal beamforming, or both.

14. The DU of claim 9, wherein the channel information capabilities comprise section type 6 capabilities, and wherein, to transmit the channel information reporting configuration, the one or more processors are individually or collectively operable to execute the code to cause the DU to:
transmit one or more section type 6 sections in accordance with the section type 6 capabilities.

15. A method for wireless communication by a radio unit (RU), comprising:
transmitting a capability report comprising one or more parameters associated with channel information capabilities, wherein the channel information capabilities are associated with a beamforming type;
receiving a channel information reporting configuration in accordance with the one or more parameters; and
transmitting a channel information report in accordance with the channel information reporting configuration and the beamforming type.

16. The method of claim 15, wherein the one or more parameters comprise a threshold quantity of channel information processing capabilities per symbol, a threshold quantity of channel information processing capabilities per slot, a maximum quantity of stored channel estimates supported by the RU, or any combination thereof.

17. The method of claim 16, wherein receiving the channel information reporting configuration comprises:
receiving channel information measurements associated with a quantity of user equipment identifiers, wherein the quantity of user equipment identifiers satisfies the threshold quantity of channel information processing capabilities per symbol, the threshold quantity of channel information processing capabilities per slot, the maximum quantity of stored channel estimates supported by the RU, or any combination thereof.

18. The method of claim 17, further comprising:
storing the channel information measurements at the RU based at least in part on the quantity of user equipment identifiers satisfying the maximum quantity of stored channel estimates supported by the RU.

19. The method of claim 15, wherein transmitting the capability report comprises:
transmitting the capability report via management plane signaling.

20. The method of claim 15, wherein the channel information reporting configuration comprises one or more channel information measurements satisfying the one or more parameters, the method further comprising:
processing the one or more channel information measurements based at least in part on the one or more channel information measurements satisfying the one or more parameters, wherein transmitting the channel information report is based at least in part on the processing.
